(19) United States
(12) Patent Application Publication
(10) Pub. No.: US 2026/0005847 A1
(43) Pub. Date: Jan. 1, 2026

(54) Security Device

(71) Applicant: Infineon Technologies AG, Neubiberg (DE)

(72) Inventor: Peter PeßL, München (DE)

(21) Appl. No.: 19/247,566

(22) Filed: Jun. 24, 2025

(30) Foreign Application Priority Data
Jun. 27, 2024 (DE) 102024118257.1

(51) Int. Cl. H04L 9/08

(52) U.S. Cl. CPC H04L 9/0869

(57) ABSTRACT

A security device comprise a sampler configured to, in each iteration of a sequence of iterations, sample a string of n bits, a bit string rejector configured to reject the string of n bits in reaction to an AND combiner generating an AND combination of the sampled bits which is equal to 1, in case a given limit or an integer multiple of the given limit is equal to 2ⁿ−1, and AND-OR combiner generating an AND combination of the most significant bit of the sampled bits with an OR combination of the other bits of the sampled bits which is equal to 1 in case the given limit is equal to 2ⁿ⁻¹+1; and a controller configured stop the sequence of iterations in reaction to a number of strings of n bits which have not been rejected being equal or above a predefined number of bit strings.

### TECHNICAL FIELD

The present disclosure relates to security in electronic devices and systems.

### BACKGROUND

With the development of quantum computers, alternatives to classical asymmetric cryptosystems like RSA (Rivest Shamir Adleman) and ECC (Elliptic Curve Cryptography) are investigated, in search of solutions that cannot be successfully attacked by quantum computers. Currently, quantum computers that are sufficiently powerful to break current cryptosystems are not available due to the technical complexity and engineering challenges, but once built they will be able to break RSA and ECC in polynomial time. Therefore, standardization bodies like NIST (National Institute of Standards and Technology) now actively investigate alternative cryptosystems. Schemes that are supposed to resist attacks by quantum computers are, among others, lattice-based public key encryption, key exchange, or signature schemes. The digital signature algorithm Dilithium was selected by NIST as the primary quantum-secure signing method and will be standardized in FIPS204 under the name ML-DSA.

Key generation in Dilithium requires uniform sampling of an integer from the range [−η, η], with η∈{2, 4}, depending on the parameter set. Rejection sampling is used on a random bitstring (output of an XOF (Extendable-output function)), and individual nibbles (i.e., bit strings of 4 bits) of this random bitstring are tested and accepted if they fall within a specified range. Depending on the parameter set, the accepted values are subject to a modular reduction. These two steps (rejection sampling and modular reduction) need to be computed in a protected manner, i.e., with a masking countermeasure applied, to protect against side-channel attacks.

Therefore, efficient approaches for generating random integers from a given range which enable protection against side-channel attacks are desirable.

The document NIST Computer Security Division. FIPS 204 (Draft): Module-Lattice-Based Digital Signature Standard, 2023, https://csrc.nist.gov/pubs/fips/204/ipd, referred to as reference 1 in the following, describes ML-DSA.

The publication Hannes GroB, Stefan Mangard, and Thomas Korak, “Domain-oriented masking: Compact masked hardware implementations with arbitrary protection order”, in TIS@CCS, page 3. ACM, 2016, referred to as reference 2 in the following, describes masked operations, in particular masked AND operations.

The publication Jean-Sebastien Coron, Johann GroBschadl, Mehdi Tibouchi, and Praveen Kumar Vadnala, “Conversion from arithmetic to boolean masking with logarithmic complexity”, in FSE, volume 9054 of Lecture Notes in Computer Science, pages 130-149. Springer, 2015, referred to as reference 3 in the following, describes masked additions.

### SUMMARY

According to various embodiments, a security device is provided, comprising a sampler circuit configured to, in each iteration of a sequence of iterations, sample a string of n bits, a bit string rejector circuit configured to, in each iteration of the sequence of iterations, reject the string of n bits in response to an AND combiner circuit of the security device generating an AND combination of the sampled bits which is equal to 1, in case a given limit or an integer multiple of the given limit is equal to 2ⁿ−1, and an AND-OR combiner circuit of the security device generating an AND combination of the most significant bit of the sampled bits with an OR combination of the other bits of the sampled bits which is equal to 1 in case the given limit is equal to 2ⁿ⁻¹+1; and a controller circuit configured to, in each iteration of the sequence of iterations, stop the sequence of iterations in reaction to a number of strings of n bits which have not been rejected being equal or above a predefined number of bit strings.

### BRIEF DESCRIPTION OF THE FIGURES

In the drawings, similar reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows an example for a security device according to an embodiment.

FIG. 2 illustrates an algorithm for deriving key coefficients.

FIG. 3 illustrates an algorithm for computing a rejection condition.

FIG. 4 shows an algorithm for parallel computation of the rejection condition.

FIG. 5 shows an illustration of a processing illustrating a parallel implementation of a rejection algorithm according to an embodiment.

FIG. 6 shows an algorithm for reducing a 4-bit number in the range [0, 14] mod 5.

FIG. 7 shows an algorithm for parallel reduction of nibbles mod 5.

FIG. 8 shows a security device according to an embodiment.

FIG. 9 shows a security device according to another embodiment.

FIG. 10 shows a flow diagram illustrating a method for generating a random number below a given limit according to an embodiment.

FIG. 11 shows a flow diagram illustrating a method for performing a modulo reduction according to an embodiment.

### DETAILED DESCRIPTION

The following detailed description refers to the accompanying drawings that show, by way of illustration, specific details and aspects of this disclosure in which the invention may be practiced. Other aspects may be utilized, and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

The examples described herein can be realized at least in part as instructions processed by a processor of a security device like a personal computer (with security measures), smart card, secure microcontroller, hardware root of trust, (embedded) secure element (ESE), Trusted Platform Module (TPM), or Hardware Security Module (HSM). Likewise, all or parts of various examples described herein can be realized with digital hardware. For convenience in describing the examples, terms such as “bit string rejector circuit,” “combiner circuit,” “controller circuit,” etc., may be used herein—it should be understood that each or any one of these circuits may be implemented using a processor circuit and corresponding instructions stored in memory or using digital hardware, such as logic gates and the like, or a combination of both. Further, it should be understood that two or more of these circuits may share hardware—for example, a sampler circuit implemented using a processor circuit and instructions stored in memory may utilize the same processor circuit used to implement a controller circuit or a modular reducer circuit.

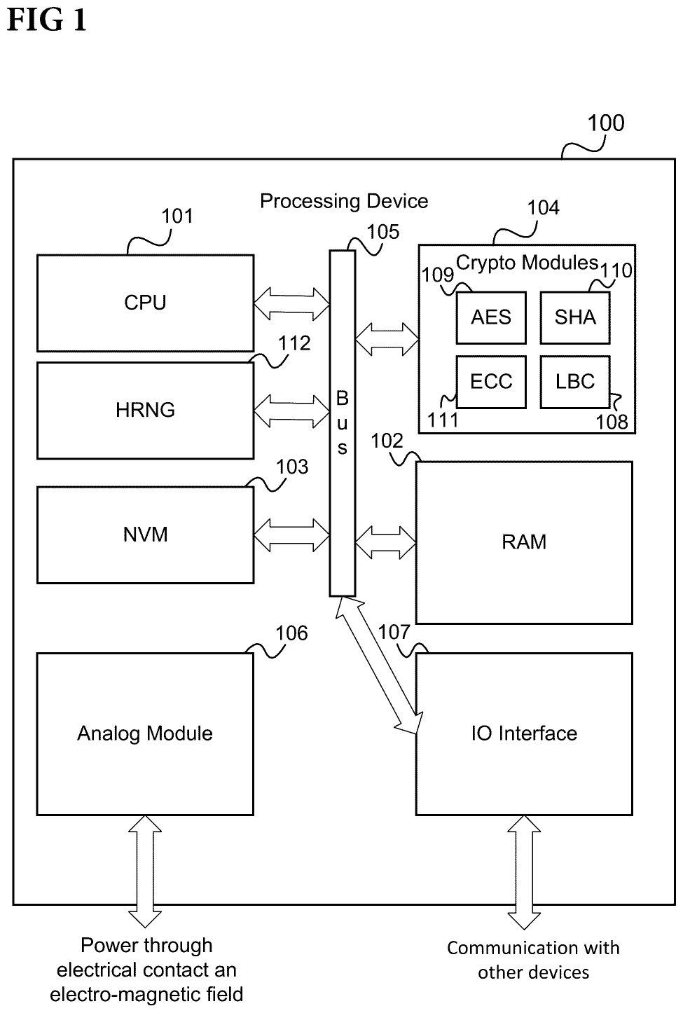

FIG. 1 shows an example for a security device 100 comprising a CPU 101, a RAM 102, a non-volatile memory 103 (NVM), a crypto module 104, an analog module 106, an input/output interface 107 and a hardware-random number generator 112.

In this example, the CPU 101 (which may for example be an application processor) has access to at least one crypto module 104 (which may be part of a hardware security module) over a shared bus 105 to which each crypto module 104 is coupled. The shared bus is only an example and there may be individual interfaces between the various components. Each crypto module 104 may in particular comprise one or more crypto cores to perform certain cryptographic operations. Exemplary crypto cores are:
an AES core 109,
a SHA core 110,
an ECC core 111, and
a lattice-based crypto (LBC) core 108.

The lattice-based crypto core 108 may be provided in order to accelerate lattice-based cryptography.

The CPU 101, the hardware random number generator 112, the NVM 103, the crypto module 104, the RAM 102 and the input/output interface 107 are connected to the bus 105. The input output interface 107 may have a connection 114 to other devices, which may be similar to the security device 100.

The analog module 106 is supplied with electrical power via an electrical contact and/or via an electromagnetic field. This power is supplied to drive the circuitry of the security device 100 and may in particular allow the input/output interface to initiate and/or maintain connections to other devices via the connection 114.

The bus 105 itself may be masked or plain. Instructions for carrying out the processing and algorithms described in the following may in particular be stored in the NVM 103 and processed by the CPU 105. The data processed may be stored in the NVM 103 or in the RAM 102. Supporting functions may be provided by the crypto modules 104 (e.g., expansion of pseudo random data). Random numbers (e.g., for masks) are supplied by the hardware-random number generator 112.

The processing and algorithms described in the following may exclusively or at least partially be conducted on the crypto module 104, e.g., on the lattice-based crypto core 108 (although they may also be performed on CPU 101 in case there is no corresponding crypto module present on the security device 100). A crypto module 104 may or may not be equipped with hardware-based security features. Such hardware-based security features could be circuits that implement countermeasures against side-channel power analysis or fault injection (e.g., using a laser). This in particular includes masking, i.e., splitting secret data into multiple shares. Such countermeasures can be realized by the use of randomness, redundant hardware, or redundant processing. In general, the goal of countermeasures is to disguise the internally processed values from an attacker who is able to observe the physical effect the processing of such values.

To perform the procedures described in the following, instructions may be stored in the lattice-based crypto core 108 or they may be provided by the CPU 101 via the bus 105. Data may be stored locally within the lattice-based crypto core 108. It is also an option that the data is temporarily stored in the RAM 102 or the NVM 103. The lattice-based crypto core 108 may also use other crypto modules to provide supporting functions (e.g., expansion of pseudo random data). The lattice-based crypto core 108 may also comprise a hardware-random number generator 112 or a means to generate physical and/or software random numbers (e.g. for masks).

The components of the security device 100 may for example be implemented on a single chip. The security device 100 may be a chip card (or a chip card module) powered by direct electrical contact or through an electro-magnetic field. The security device 100 may be a fixed circuit or based on reconfigurable hardware (e.g., Field Programmable Gate Array, FPGA). The security device 100 may be coupled to a personal computer, microcontroller, FPGA or a smart phone System on a Chip (SoC) or other components of a smart phone. The security device 100 may be a chip that acts as Trusted Platform Module (TPM) offering cryptographic functionality (secure storage, secure time, signature generation and validation, attestation) according to a standardized interface to a computer, smart phone, Internet of Things (IoT) device, or car.

According to various embodiments, the security device 100 in particular performs, as cryptographic operation (i.e. cryptographic processing), the digital signature algorithm Dilithium (also referred to as ML-DSA).

Key generation in Dilithium requires uniform sampling of an integer from the range [−η, η], with η∈{2, 4}, depending on the parameter set. Rejection sampling is used on a random bitstring (output of an XOF): the individual nibbles (4 bits) of this random bitstring are tested and accepted if they fall within a specified range. Depending on the parameter set, the accepted values are subject to a modular reduction.

According to various embodiments, an approach is provided which allows performing at least one of these two steps (rejection sampling and modular reduction) in a protected manner, i.e., with a masking countermeasure applied, to protect against side-channel attacks. Specifically, the two steps are performed using simple Boolean arithmetic which may be performed in a masked manner, e.g. using already available masked gadgets (e.g. for performing a masked AND, a masked OR, etc.). Further, due to processing only small values, multiple numbers (coefficients in the Dilithium case) may be processed in parallel (Single-Instruction-Multiple-Data SIMD), which is beneficial for efficiency and side-channel security reasons.

According to various embodiments, instead of performing a subtraction, the rejection test is done by computing a simple logical combination of the 4 bits. This can be performed in parallel on, for example, all 8 coefficients in a 32-bit word, and only requires few relatively simple logical operations (ANDs, ORs). The modular reduction is for example done through trial subtraction, but the data is prepared such that, e.g., an existing 32-bit masked addition can be used to perform the subtraction on 8 nibbles in parallel (carries between nibbles are avoided).

The key generation of ML-DSA is specified in reference 1, section 5. In brief, the public key t is computed as t=As₁+s₂, where s₁, s₂ are the core components of the private key and A∈R_{q}^{k×l} is a polynomial matrix where R is the ring of single-variable polynomials over [symbol] _{q}[X]/(X²⁵⁶+1). The secret elements s₁, s₂ are vectors of polynomials with n=256 coefficients; they are generated in the function ExpandS (see reference 1). The individual coefficients of s₁ and s₂ are sampled from the discrete uniform distribution over the interval [−η, η], where η=2 for the parameter sets ML-DSA-44 and ML-DSA-87, and η=4 for the parameter set ML-DSA-65 (see reference 1 for details about these parameter sets). A specific implementation of rejection sampling is used to generate the coefficients from random bits (which are generated via the SHAKE XOF (Extendable-output function) using a secret seed as input). The concrete rejection-sampling method from reference 1 is as follows:

Algorithm CoeffFromHalfByte(b) (Algorithm 9 in reference 1)

| Generates an element of {−η, −η + 1,..., η}∪{⊥}. | |
|---|---|
| Input: Integer b ∈ {0, 1,..., 15}. | |
| Output: An integer between −η and η, or ⊥. | |
| 1: | if η = 2 and b < 15 then return 2 − (b mod 5) |
| 2: | else |
| 3: | if η = 4 and b < 9 then return 4 − b |
| 4: | else return ⊥ |
| 5: | end if |
| 6: | end if |

The algorithm CoeffFromHalfByte(b) takes a HalfByte, i.e., 4 bits (also known as a nibble), as input. It tries to generate a uniformly distributed value c in the range [0,2η]. If η=2, then the input value 15 is rejected, leaving the (2η+1)·3=5·3=15 values in [0, 14]. A modular reduction by (2η+1)=5 then gives the desired value. If 1=4, then 2η=8, meaning that values greater or equal to 9 are rejected. Upon acceptance, the output is shifted to the target interval [−η, η] by subtracting c from f. The “Up Tack” or “Falsum” symbol ⊥ denotes a rejection.

When packing the key into the format described in reference 1, then the subtraction of c from η is reverted, as now explained. The packing procedure for packing the key calls the algorithm BitPack, shown as follows with inputs a=b=η:

Algorithm BitPack(w, a, b) for packing coefficients
into a byte array (Algorithm 11 from reference 1)

| Encodes a polynomial w into a byte string. | | |
|---|---|---|
| Input: a, b ∈ [symbol] and w ∈ R such | | |
| that the coefficients of w are all in [−a,b]. | | |
| Output: A byte string of length 32·bitlen (a + b). | | |
| 1: | z ← ( ) | [symbol] set z to the empty string |

| | |
|---|---|
| 2: | for i from 0 to 255 do |
| 3: | z ← z\|\|IntegerToBits(b − wᵢ,bitlen (a + b)) |
| 4: | end for |
| 5: | return BitsToBytes(z) |

The algorithm BitPack has the inputs a=b=η (see reference 1). In the BitPack algorithm, the input is subtracted from b. If the (accepted) output of CoeffFromHalfByte is used here, then one receives b−(c−η)=η−c+η=c. Thus, the value c∈[0, 2η] is packed, into either 3 (η=2) or 4 (η=4) bits.

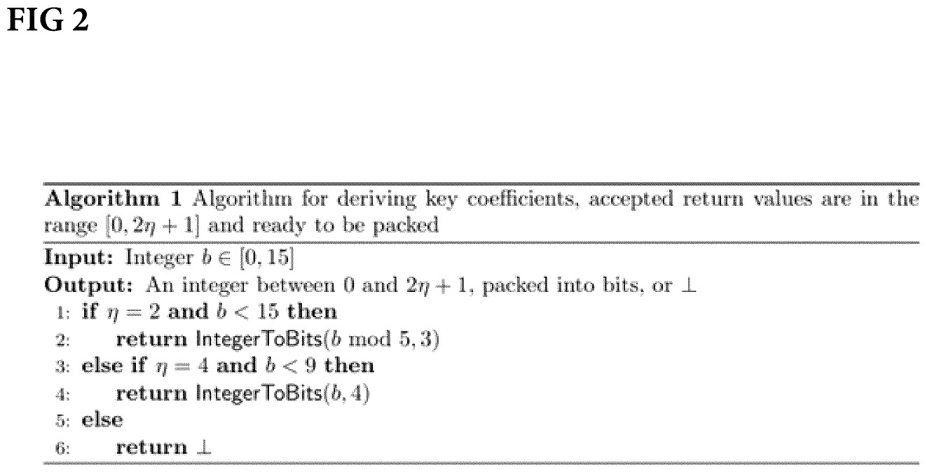

Thus, the generation of the packed key can also be written as shown in Algorithm 1, which is illustrated in FIG. 2.

The sampling procedure for the individual coefficients of s₁ and s₂ is highly sensitive and needs to be protected against side-channel attacks using, e.g., masking. However, masking is not trivially applicable to the sampling algorithm. When implemented in plain (unprotected), then the test if b<15 or b<9 is typically done by extracting the input nibble, performing a subtraction of the comparison value, and finally checking the sign bit. Directly masking this procedure requires performing a masked subtraction for each nibble, which is costly. Also, this operation operates on very few bits, which might make attacks easier. Finally, it is not trivially parallelizable using standard CPU instructions, as performing a subtraction on a full CPU word containing multiple nibbles could introduce unwanted carries propagating over nibble boundaries. Additionally, for the reduction mod 5, which is required in case η=2, similar reasons hold. In plain, this reduction could be performed, e.g., through conditional subtraction of the modulus (at most 2 times) or by using another reduction technique (division, Montgomery, or Barrett reductions). In the masked setting, the input data is likely Boolean masked, meaning that performing the latter techniques requires costly masking conversions (Boolean-to-arithmetic and arithmetic-to-Boolean masking). Conditional subtractions can be directly performed on masked data but cannot be easily parallelized (due to the same reasons as given above).

In the following, approaches for checking whether a nibble is in a suitable range (i.e. for rejection testing) and for modular reduction are described which allow parallel operations on multiple nibbles (using standard CPU instructions) and reuse of (potentially already existing) masked operations (addition, and Boolean operations, in particular (bit-wise) AND etc.) are provided.

In the following, (logical) shifts to the right are denoted using >>. Further, in the following, bit-wise operations are denoted using C-style notation. That is, bit-wise AND is denoted by &, bit-wise OR is denoted by |, bit-wise XOR is denoted by \hat{ } and bit-wise negation is denoted by ˜.

For rejection testing (in the present example testing whether the sampled nibble is lower than 15 or 9, respectively), instead of performing a masked subtraction of either 15 or 9, the limit is tested by logically combining the bits of b.

In case η=2, the only rejected value is 15, which is the only 4-bit value having all bits set to 1. Thus, computing the AND combination over all 4 bits reveals the rejection condition.

If η=4, then all values where the most significant bit (MSB) of b equals 0 (values 0 through 7) are accepted. From the values with set MSB (values 8 through 15), only 8 must be accepted. This is the only value where apart from the MSB, no other bit is set to 1. In other words, a value must be rejected if the MSB and at least one other bit is set.

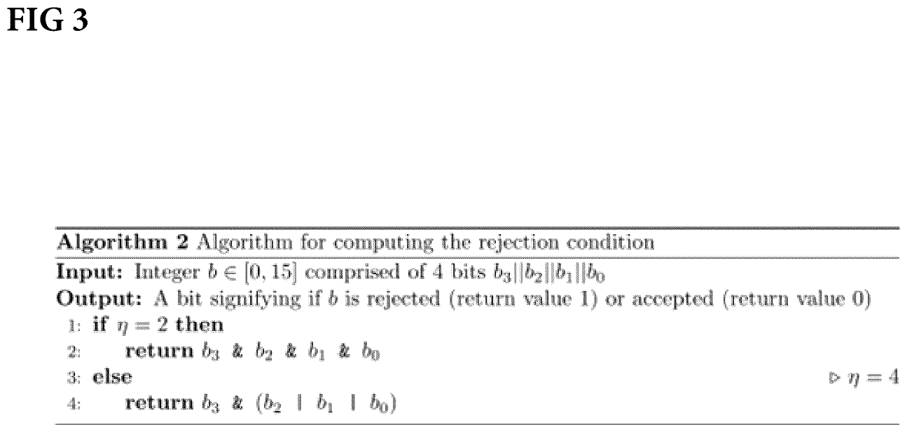

The above is formalized in Algorithm 2, which is illustrated in FIG. 3.

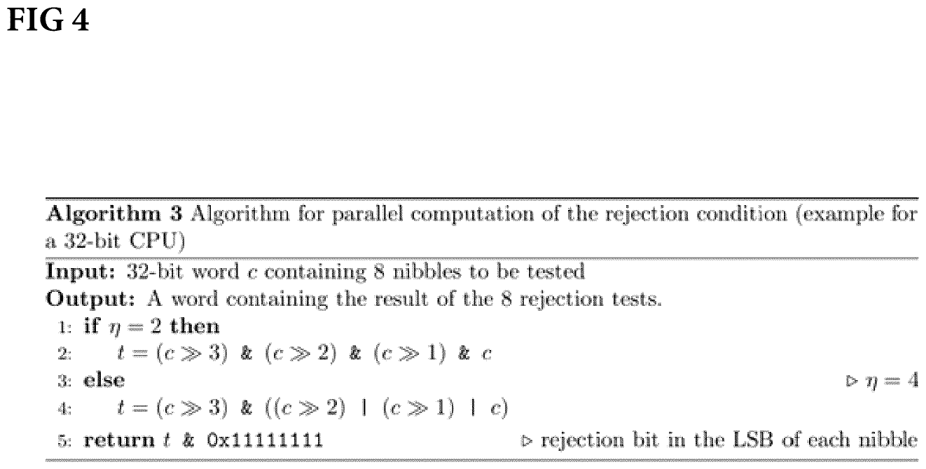

Algorithm 2 can be easily computed on multiple nibbles in parallel, as shown in Algorithm 3, which is illustrated in FIG. 4.

Algorithm 3 only requires simple logical operations and bit shifts. The example assumes usage of a 32-bit CPU, but the approach can be easily adapted to any other common word size. The statement in line 2 can alternatively be computed using the following two operations, saving one AND operation:

$$\begin{matrix}t = ( c ≫ 1 ) \& c \\ t = ( t ≫ 1 ) \& t .\end{matrix}$$

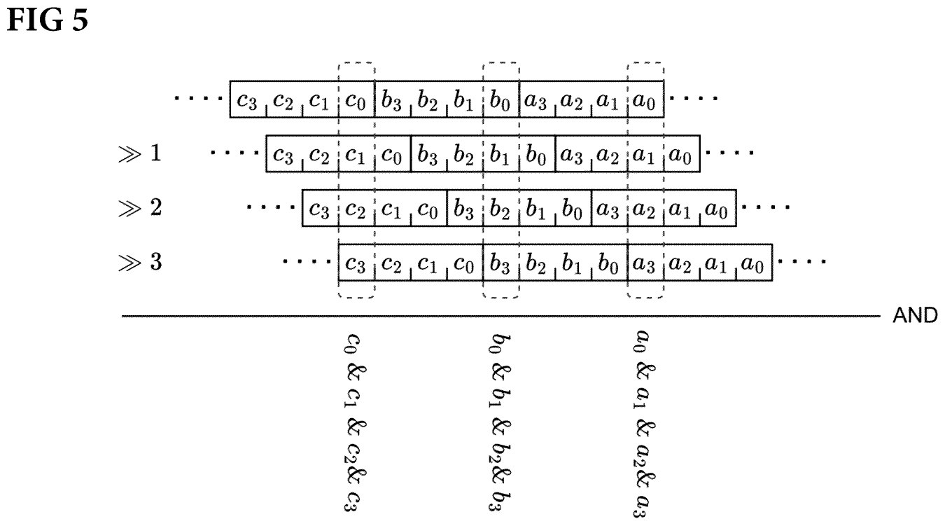

FIG. 5 shows an illustration of a processing 200 illustrating the parallel implementation of algorithm 3 for the case η=2.

Further, algorithm 3 can be easily run in a masked manner. It is sufficient to compute the variable t masked, i.e., use masked AND/OR operations for combining the (also masked) input bits, e.g. using masked AND operations as described in reference 2 (and e.g. replacing ORs by (masked) ANDs using de Morgan's law). The final extraction of the LSB can be done on a share-per-share basis. The final output can be unmasked, as the rejection decision is not security sensitive.

The modular reduction (by 5 in the present example for the case η=2) is (also) designed such that it can be computed on all nibbles of a CPU word in parallel. The function requires computation of a masked addition, but it can reuse existing implementations (performing additions of full CPU words). Operations preceding the addition make sure that the masked operation does not lead to a carry propagation over nibbles, which would falsify the outcome.

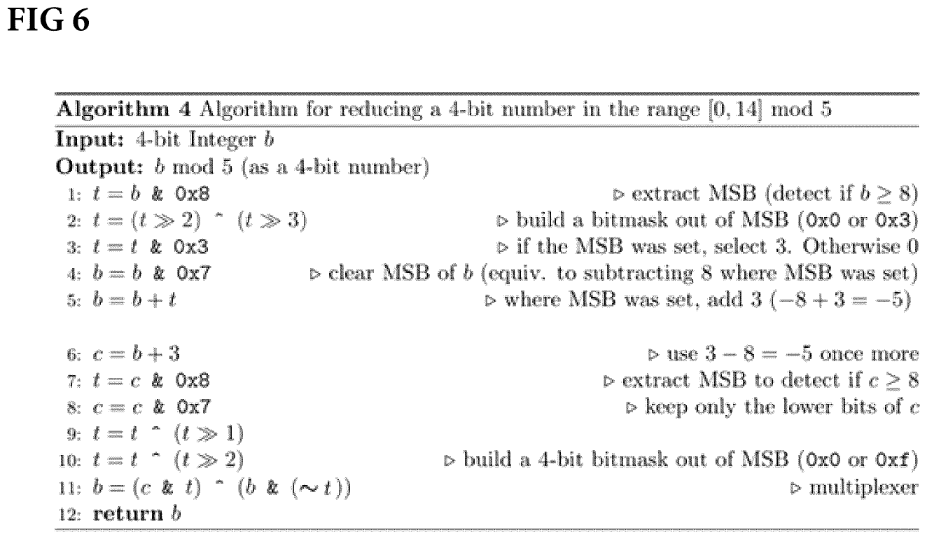

Algorithm 4, which is illustrated in FIG. 6, is a concrete example (for modular reduction of a single nibble). It essentially consists of two conditional subtractions of 5.

In a first step, the MSB of the input is tested and then cleared, the outcome is stored in variable b. Clearing the MSB (if it was set) is equivalent to subtracting 8 from the numbers in the range [8, 14]. To get the correct result, 3 must be added after subtracting 8 (as −8+3=−5). This (conditional) addition is done by constructing a bitmask out of the MSB, using this bitmask on the constant 3, and adding the result to b. As both operands of this addition have their MSB set to 0, it is ensured that no carry propagates over the 4-bit boundary. This makes it possible to perform this addition on multiple nibbles in parallel using a standard, e.g., 32-bit, (masked) addition. After this first conditional subtraction, the input is reduced to the range [0, 9]. The second conditional subtraction also uses the congruence 3=−5 mod 8. The constant 3 is added to the intermediate. Since the maximum outcome of this addition is 9+3=12, carry propagation over nibble boundaries is also prevented here. If the MSB is set after the addition, then 8 is subtracted (i.e., the MSB is cleared again). A multiplexer is then used to select either b (MSB after addition was 0) or b+3−8 (MSB after addition was 1). Algorithm 4 as written above uses plain logic operations. For a masked implementation, all operations (including the addition) need to be replaced with their masked counterparts. Also, it is stated in Algorithm 4 that the input must be in [0, 14], i.e., rejection sampling (e.g. as described above) is done earlier. However, feeding 15 into the algorithm does also not result in an error or influence neighboring nibbles, the only effect is that the output is not fully reduced (algorithm outputs 5 instead of 0).

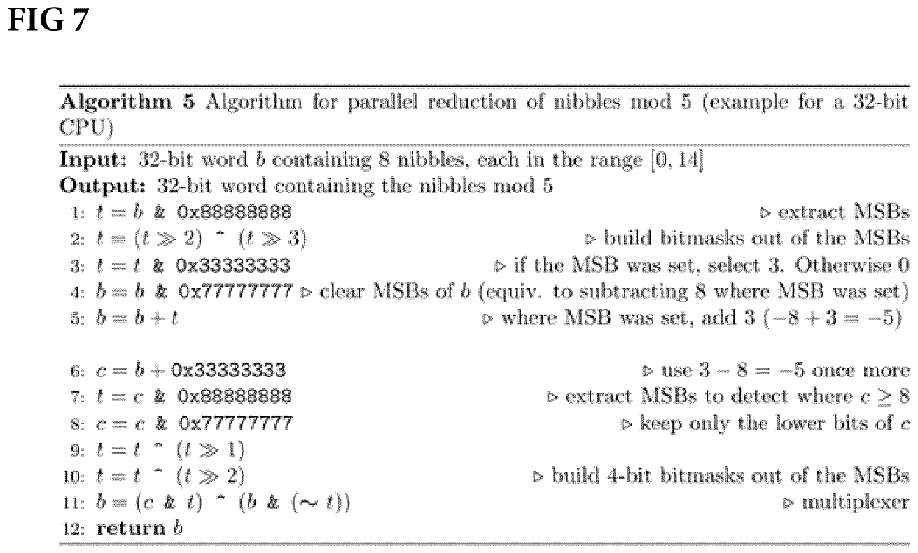

Algorithm 4 can be parallelized as shown in Algorithm 5, which is illustrated in FIG. 7.

Algorithm 5 Algorithm for parallel reduction of nibbles mod 5 (example for a 32-bit CPU)

Input: 32-bit word b containing 8 nibbles, each in the range [0, 14]
Output: 32-bit word containing the nibbles mod 5

| 1: | t = b & 0x88888888 | [symbol] extract MSBs |
|---|---|---|
| 2: | t = (t >> 2) \hat{ } (t >> 3) | [symbol] build bitmasks out of the MSBs |
| 3: | t = t & 0x33333333 | [symbol] if the MSB was set, select 3. Otherwise 0 |
| 4: | b = b & 0x77777777 | [symbol] clear MSBs of b (equiv, to subtracting 8 where MSB was set) |
| 5: | b = b + t | [symbol] where MSB was set, add 3 (−8 + 3 = −5) |
| 6: | c = b + 0x33333333 | [symbol] use 3 − 8 = −5 once more |
| 7: | t = c & 0x88888888 | [symbol] extract MSBs to detect where c ≥ 8 |
| 8: | c = c & 0x77777777 | [symbol] keep only the lower bits of c |
| 9: | t = t \hat{ } (t >> 1) | |
| 10: | t = t \hat{ } (t >> 2) | [symbol] build 4-bit |
| | | bitmask out of the MSBs |
| 11: | b = (c & t) \hat{ } | [symbol] multiplexer |

| | |
|---|---|
| | (b & (~ t)) |
| 12: | return b |

For the masked variants, all operations are replaced with their masked counterparts, e.g. according to reference 2 for AND operations and according to reference 3 for the addition operations.

The full sampling algorithm could, e.g., feed the XOF output into Algorithm 3 (32 bits at a time). The accepted nibbles are then copied into another buffer. If η=2, the values in this buffer are the fed into Algorithm 5 (again 32 bits at a time) and re-packing the output from 4 to 3 bits per coefficient. Alternatively, one can run both Algorithm 3 and Algorithm 5 on the XOF output and only then copy the accepted coefficients into the output.

As mentioned above, the algorithms discussed above are given in plain, i.e., unmasked form, but they can easily be transformed into masked variants by replacing all operations with their masked counterparts. The masked addition (i.e. masked adding operation) can be performed using any (masked) addition functionality, such as a function adding 32-bit words. The addition could also be optimized by exploiting the fact that no carry can propagate over nibble boundaries. The general methods can also be applied on bitsliced representations of the data.

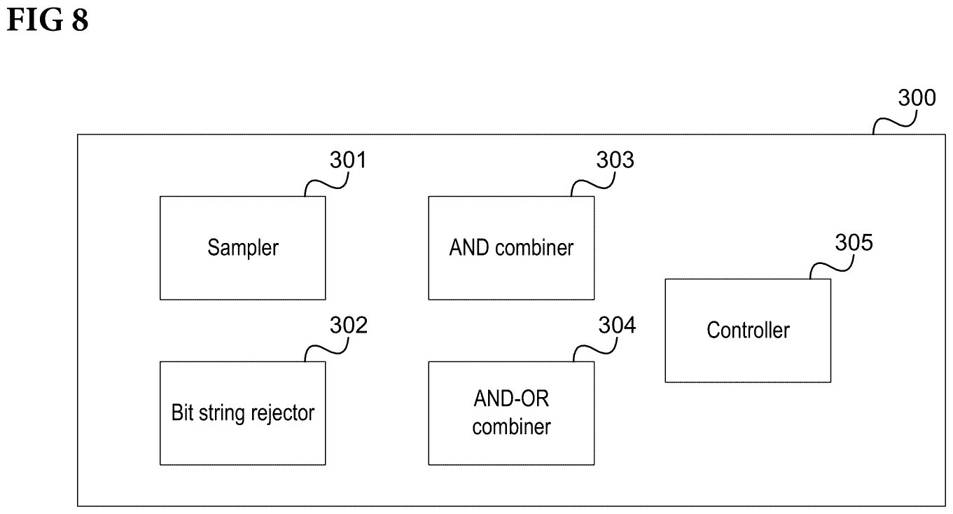

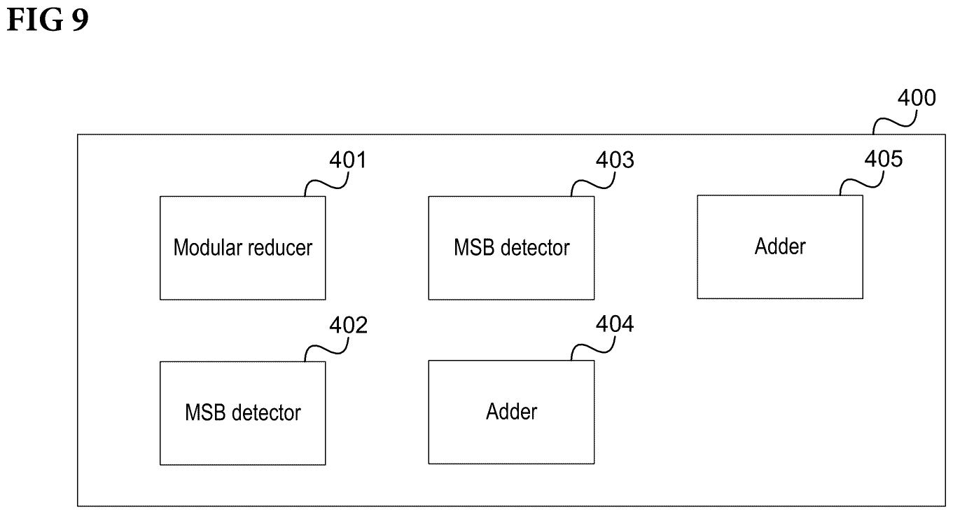

In summary, according to various embodiments, a security device is provided as illustrated in FIG. 8 and/or as illustrated in FIG. 9 (i.e. in particular a security device may be provided which includes the features of both FIGS. 8 and 9).

FIG. 8 shows a security device 300 according to an embodiment.

The security device 300 comprises a sampler circuit 301 configured to, in each iteration of a sequence of (random number generation) iterations, sample a string of n bits (also referred to as “nibble” in the examples above). Hereinafter, sampler circuit 301 may be referred to as simply sampler 301.

The security device 300 further comprises a bit string rejector circuit 302 configured to, in each iteration of the sequence of iterations, reject the string of n bits in reaction to
a first AND combiner circuit 303 of the security device 300 generating an AND combination (i.e. the result of a bit-wise Boolean AND operation) of the sampled bits (i.e. the bits of the sampled string of n bits) which is equal to 1, in case a given limit (below which a random number is to be generated) or an integer multiple of the given limit is equal to 2ⁿ−1,
an AND-OR combiner circuit 304 (i.e. a function or functional block or processor configured to perform an AND combination and an OR combination, in this case an AND combination which has one operand which is an OR combination) of the security device 300 generating an AND combination (i.e. the result of a bit-wise Boolean AND operation) of the most significant bit of the sampled bits with an OR combination of the other bits (except the most significant bits, i.e. the least significant bits) of the sampled bits which is equal to 1 in case the given limit is equal to 2ⁿ⁻¹+1.

Hereinafter, the bit string rejector circuit 302, first AND combiner circuit 303, and AND-OR combiner circuit 304 may be referred to as simply bit string rejector 302, first AND combiner 303, and AND-OR combiner 304, respectively.

The security device 300 further comprises a controller circuit 305 configured to, in each iteration of the sequence of iterations, stop the sequence of iterations in reaction to a number of strings of n bits which have not been rejected being equal or above a predefined (required) number of bit strings (i.e. stop when the number of non-rejected bit strings is sufficient; in other words, continue until a sufficient number of bit strings which were not rejected has been reached). Hereinafter, controller circuit 305 may be referred to as simply controller 305.

FIG. 9 shows a security device 400 according to an embodiment.

The security device 400 comprises a modular reducer circuit 401 configured to perform a modulo reduction by a modulus of each binary number of a sequence of binary numbers forming a data word (i.e. the binary numbers, when written one after the other, form the data word), wherein each binary number consists of n bits and the modulus is smaller than 2ⁿ⁻¹−1 (5 in the above example which is smaller than 2⁴−1−1=7; this limitation allows modular reduction by deleting the MSB (which corresponds to the value 2ⁿ, i.e. 8 in the above example)) by processing each binary number of the sequence by
one or more first iterations comprising
   in reaction to a first detector circuit 402 of the security device 400 detecting that the most significant bit of the binary number is set,
      changing the binary number by deleting its most significant bit and,
      further changing (i.e. after changing the binary number by deletion of the most significant bit) the binary number by adding (e.g. by a first adder 404 of the security device 400) the difference between 2ⁿ⁻¹ and the modulus (in the above example, this difference is 8−5=3) to the binary number (and continue with the binary number as changed in the next first iteration or in a second iteration (see below); in other words, the binary number resulting from the processing by the first iteration is assigned to the binary number to continue with this resulting binary number). The adding is not performed if the most significant bit of the binary number was not set and thus was also not deleted; so, in other words, the addition is performed in reaction to the deletion of the most significant bit. It should be noted that according to various embodiments, any conditional operation may be done through bit masking one operand. For instance: there is always an addition operation, but it adds either 3 or 0 (so the addition of 3 is conditionally performed). The deletion of the MSB before the addition ensures that there is no overflow in the addition (into an adjacent binary number in an embodiment where the data word is processed as a whole),
followed by one or more second iterations (i.e. the second iterations operate on the binary number as it results from the one or more first iterations) comprising
   in reaction to a second detector circuit 403 of the security device detecting that the most significant bit of the sum of the binary number with the difference between 2ⁿ⁻¹ and the modulus (again, in the above example, this difference is 8−5=3) is set,
      setting the binary number to the sun (e.g, calculated by a second adder 405 of the security device 400) of the binary number and the difference between 2ⁿ⁻¹ and the modulus, wherein the most significant bit of the sum is deleted (if the MSB of the sum is not set than keep the binary number unchanged; the one or more second iterations may then be stopped, i.e. no further second iteration then needs to be performed).

Hereinafter, modular reducer circuit 401, first detector circuit 402, and second detector circuit 403 may be referred to as simply modular reducer 401, first detector 402, and second detector 403.

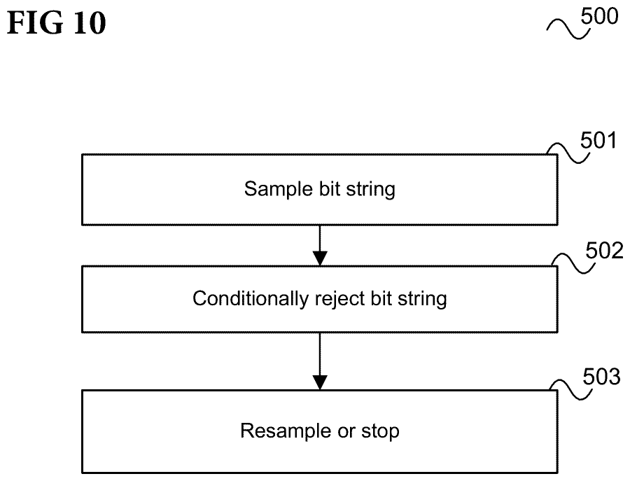

FIG. 10 shows a flow diagram 500 illustrating a method for generating a random number below a given limit (according to a uniform distribution over the given range) in manner robust against side-channel attacks according to an embodiment.

The given limit or a multiple of the given limit is equal to 2ⁿ⁻¹(15 in the above examples, with n=4) or the given limit is equal to 2ⁿ⁻¹+1 (9 in the above examples with n=4). It should be noted that n is the minimum number of bits with which all of the numbers below the given limit can be represented (as binary numbers, i.e. when the n bits are used to represent an n-bit binary numbers, the combinations of all possible values of the bits include all numbers below the given limit).

The method comprises, in each iteration of a sequence of (random number generation) iterations,
in 501 sampling a string of n bits (wherein either the given limit or a multiple of the given limit is equal to 2ⁿ⁻¹(15 in the above examples, with n=4) or the given limit is equal to 2ⁿ⁻¹+1 (9 in the above examples with n=4))
in 502 rejecting the string of n bits in reaction to
   an AND combination of the sampled bits being equal to 1, in case the given limit or an integer multiple of the given limit is equal to 2ⁿ⁻¹,
   an AND combination of the most significant bit of the sampled bits with an OR combination of the other bits (except the most significant bits, i.e. the least significant bits) of the sampled bits being equal to 1 in case the given limit is equal to 2ⁿ⁻¹+1; and
in 503 continuing with a next iteration of the sequence of iterations in reaction to the bit string rejector rejecting the string of n bits and stopping the sequence of iterations in reaction to a number of strings of n bits which have not been rejected being equal or above a predefined (required) number of bit strings (i.e. stop when the number of non-rejected bit strings is sufficient; in other words, continue until a sufficient number of bit strings which were not rejected has been reached).

According to various embodiments, in other words, rejection sampling is performed by Boolean combinations of the bits of sampled bit strings. This in particular allows efficient side-channel attack protection because the Boolean combinations can be more easily performed in masked manner (compared to a masked addition).

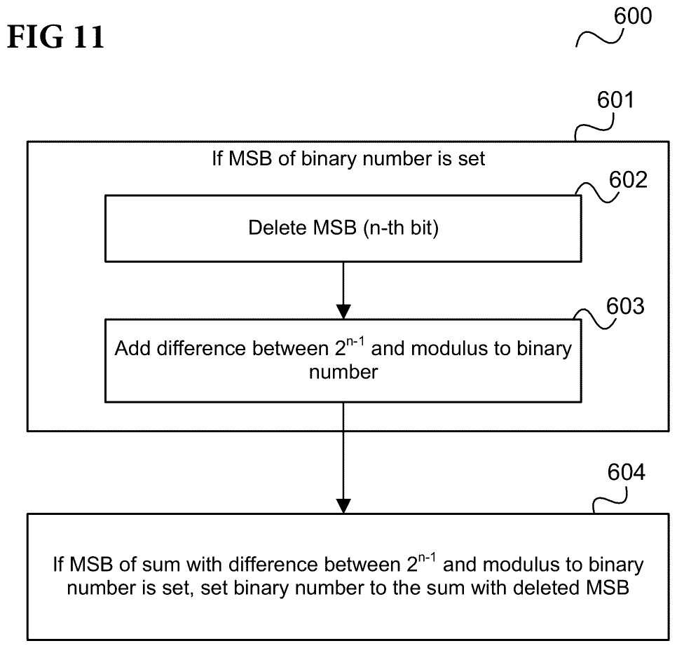

FIG. 11 shows a flow diagram 600 illustrating a method for performing a modulo reduction by a modulus of each binary number of a sequence of binary numbers forming a data word (i.e. the binary numbers, when written one after the other, form the data word) in manner robust against side-channel attacks, wherein each binary number consists of n bits and the modulus is smaller than 2ⁿ⁻¹−1 (5 in the above example which is smaller than 2⁴⁻¹−1=7; this limitation allows modular reduction by deleting the MSB (which corresponds to the value 2ⁿ⁻¹, i.e. 8 in the above example)).

Each binary number of the sequence is processed by
in 601 one or more first iterations comprising
   in reaction to the most significant bit of the binary number being set
      in 602 changing the binary number by deleting its most significant bit and,
      in 603 further changing (i.e. after changing the binary number by deletion of the most significant bit) the binary number by adding the difference between 2ⁿ⁻¹ and the modulus (in the above example, this difference is 8−5=3) to the binary number (and continued with the binary number as changed in the next first iteration or in a second iteration (see below); in other words, the binary number resulting from the processing by the first iteration is assigned to the binary number to continue with this resulting binary number). The adding is not performed if the most significant bit of the binary number was not set and thus was also not deleted; so, in other words, the addition is performed in reaction to the deletion of the most significant bit. The deletion of the MSB before the addition ensures that there is no overflow in the addition (into an adjacent binary number in an embodiment where the data word is processed as a whole)
followed by, in 604, one or more second iterations (i.e. the second iterations operate on the binary number as it results from the one or more first iterations) comprising
   in reaction to the most significant bit of the sum of the binary number with the difference between 2ⁿ⁻¹ and the modulus (again, in the above example, this difference is 8−5=3) being set, setting the binary number to the sum of the binary number and the difference between 2ⁿ⁻¹ and the modulus, wherein the most significant bit of the sum is deleted (if the MSB of the sum is not set than keep the binary number unchanged; the one or more second iterations may then be stopped, i.e. no further second iteration then needs to be performed).

According to various embodiments, in other words, modulo reduction is performed in such a manner that multiple binary numbers can be reduced in parallel by processing a data word containing the binary numbers without causing errors due to carry bit propagation from one binary number to another binary number. This allows reuse of potentially already existing masked adders and efficient side-channel attack protection due to a higher noise level through increased parallel activity compared to non-parallel processing of the binary numbers.

Various Examples for the two aspects according to FIGS. 8 and 9 (and FIGS. 10 and 11) are described in the following.

Example 1 according to the first aspect is a security device as described with reference to FIG. 8.

Example 2 according to the first aspect is the security device of example 1 according to the first aspect, wherein the controller is configured to continue with a next iteration of the sequence of iterations in reaction to the bit string rejector rejecting the string of n bits (that was sampled in the iteration). (In other words, in reaction to a string of n bits being rejected, a new string of n bits is resampled (and the security device continues like this, i.e. possibly reject the resampled string and resample again) until a string of n bits is found that is not rejected.)

Example 3 according to the first aspect is the security device of example 1 or 2 according to the first aspect, further comprising a modular reducer configured to perform modular reduction of the binary number represented by the string of n bits sampled in the iteration in which the controller stops the sequence of iterations in case that the integer multiple of the given limit is equal to 2ⁿ⁻¹.

Example 4 according to the first aspect is the security device of any one of examples 1 to 3 according to the first aspect, wherein the sampler is configured to, in each iteration of the sequence of iterations, sample multiple strings of n bits, the bit string rejector is configured to, in each iteration of the sequence of iterations, for each of the sampled strings of n bits, reject the string of n bits in reaction to
the AND combiner of the security device generating an AND combination of the sampled bits (i.e. the bits of the sampled string of n bits) which is equal to 1, in case the given limit or an integer multiple of the given limit is equal to 2ⁿ⁻¹,
the AND-OR combiner of the security device generating an AND combination of the most significant bit of the sampled bits with an OR combination of the other bits (except the most significant bits, i.e. the least significant bits) of the sampled
bits which is equal to 1 in case the given limit is equal to 2ⁿ⁻¹+1; and
the controller is configured to, in each iteration of the sequence of iterations, continue with a next iteration of the sequence of iterations until a number of strings of n bits has not been rejected which is equal or above a predefined number of bit strings.

Example 5 according to the first aspect is the security device of example 4 according to the first aspect, wherein, in each iteration of the sequence of iterations, the AND combiner is configured to determine the AND combinations of the sampled bits for all of the strings of bits that were sampled in the iteration concurrently (e.g. in parallel).

Example 6 according to the first aspect is the security device of example 4 or 5 according to the first aspect, wherein, in each iteration of the sequence of iterations, the AND-OR combiner is configured to determine the AND combination of the most significant bit of the sampled bits with the OR combination of the other bits of the sampled bits for all of the strings of bits that were sampled in the iteration concurrently (e.g. in parallel).

Example 7 according to the first aspect is the security device of any one of examples 1 to 6 according to the first aspect, wherein, in each iteration of the sequence of iterations, the AND combiner is configured to determine the AND combination of the sampled bits by means of a masked AND operation.

Example 8 according to the first aspect is the security device of any one of examples 1 to 7 according to the first aspect, wherein, in each iteration of the sequence of iterations, the AND-OR combiner is configured to determine the AND combination of the most significant bit of the sampled bits with the OR combination of the other bits of the sampled bits by means of a masked AND operation and to perform the OR combination of the other bits of the sampled bits by means of a masked OR combination.

Example 9 according to the first aspect is a method for generating a random number below a given limit in manner robust against side-channel attacks as described with reference to FIG. 10.

Example 1 according to the second aspect is a security device as described above with reference to FIG. 9.

Example 2 according to the second aspect is the security device of example 1 according to the second aspect, wherein the modular reducer is configured to perform the one or more first iterations concurrently (e.g. in parallel) on the binary numbers (by processing the data word as a whole).

Example 3 according to the second aspect is the security device of example 1 or 2 according to the second aspect, wherein the modular reducer is configured to perform the one or more second iterations concurrently (e.g. in parallel) on the binary numbers (by processing the data word as a whole).

Example 4 according to the second aspect is the security device of any one of examples 1 to 3 according to the second aspect, wherein the modular reducer is configured to perform the adding of the difference between 2ⁿ⁻¹ and the modulus to the binary number by a masked addition.

Example 5 according to the second aspect is the security device of any one of examples 1 to 4 according to the second aspect, wherein the modular reducer is configured to determine the sum of the binary number and the difference between 2ⁿ⁻¹ and the modulus, wherein the most significant bit of the sum is deleted, by a masked addition.

Example 6 according to the second aspect is the security device of any one of examples 1 to 5 according to the second aspect, wherein the first detector is configured to detect whether the most significant bit of the binary number is set by an AND operation.

Example 7 according to the second aspect is the security device of any one of examples 1 to 6 according to the second aspect, wherein the second detector is configured to detect whether the most significant bit of the sum of the binary number with the difference between 2ⁿ⁻¹ and the modulus is set by an AND operation.

Example 8 according to the second aspect is the security device of any one of examples 1 to 7 according to the second aspect, wherein the first detector is configured to detect concurrently (e.g. in parallel) whether the most significant bits of the binary numbers of the sequence of binary numbers are set.

Example 9 according to the second aspect is the security device of any one of examples 1 to 8 according to the second aspect, wherein the second detector is configured to detect concurrently (e.g. in parallel) whether the most significant bits of the sums of the binary numbers with the difference between 2ⁿ⁻¹ and the modulus are set.

Example 10 according to the second aspect is the security device of any one of examples 1 to 9 according to the second aspect, wherein the modular reducer is configured to add the difference between 2ⁿ⁻¹ and the modulus to the binary number in reaction to the first detector of the security device detecting that the most significant bit of the binary number is set by constructing a bit mask for the difference between 2ⁿ⁻¹ and the modulus to the binary number from the most significant bit of the binary number and adding the difference between 2ⁿ⁻¹ and the modulus, masked by the bit mask, to the binary number.

Example 11 according to the second aspect is a method for performing a modulo reduction by a modulus of each binary number of a sequence of binary numbers forming a data word in manner robust against side-channel attacks as described with reference to FIG. 11.

The examples of the first aspect and the second aspect may also be combined.

The components of the security devices 300, 400 of FIGS. 8 and 9 (e.g. the sampler, bit string rejector, controller, combiners, modular reducer, MSB detectors and adders) may be implemented and the methods of FIGS. 10 and 11 may be performed by one or more data processing devices (e.g. computers or microcontrollers) having one or more data processing units or processors and one or more memories (storing data to be processed and instructions according to which the data is processed). The term “data processing unit” and “processor” may be understood to mean any type of entity that enables the processing of data or signals. For example, the data or signals may be handled according to at least one (i.e., one or more than one) specific function performed by the data processing unit. A data processing unit or processor may include or be formed from an analog circuit, a digital circuit, a logic circuit, a microprocessor, a microcontroller, a central processing unit (CPU), a graphics processing unit (GPU), a digital signal processor (DSP), a field programmable gate array (FPGA), or any combination thereof. Any other means for implementing the respective functions described in more detail herein may also be understood to include a data processing unit, processor or logic circuitry. One or more of the method steps described in more detail herein may be performed (e.g., implemented) by a data processing unit or processor through one or more specific functions performed by the data processing unit.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A security device, comprising:
a sampler circuit configured to, in each iteration of a sequence of iterations, sample a string of n bits;
a bit string rejector circuit configured to, in each iteration of the sequence of iterations,
reject the string of n bits in reaction to
an AND combiner circuit of the security device generating an AND combination of the sampled bits which is equal to 1, in each case where a given limit or an integer multiple of the given limit is equal to 2ⁿ⁻¹, and
an AND-OR combiner circuit of the security device generating an AND combination of the most significant bit of the sampled bits with an OR combination of the other bits of the sampled bits which is equal to 1, in each case where the given limit is equal to 2ⁿ⁻¹+1; and
a controller circuit configured to, in each iteration of the sequence of iterations, stop the sequence of iterations in reaction to a number of strings of n bits which have not been rejected being equal or above a predefined number of bit strings.

2. The security device of claim 1, wherein the controller circuit is configured to continue with a next iteration of the sequence of iterations in reaction to the bit string rejector circuit rejecting the string of n bits.

3. The security device of claim 1, further comprising a modular reducer circuit configured to perform modular reduction of the binary number represented by the string of n bits sampled in the iteration in which the controller circuit stops the sequence of iterations in case that the integer multiple of the given limit is equal to 2ⁿ⁻¹.

4. The security device of claim 1, wherein the sampler circuit is configured to, in each iteration of the sequence of iterations, sample multiple strings of n bits, and wherein the bit string rejector circuit is configured to, in each iteration of the sequence of iterations, for each of the sampled strings of n bits,
reject the string of n bits in reaction to
the AND combiner circuit of the security device generating an AND combination of the sampled bits which is equal to 1, in each case where the given limit or an integer multiple of the given limit is equal to 2ⁿ⁻¹,
the AND-OR combiner circuit of the security device generating an AND combination of the most significant bit of the sampled bits with an OR combination of the other bits of the sampled bits which is equal to 1, in each case where the given limit is equal to 2ⁿ⁻¹+1; and
the controller circuit is configured to, in each iteration of the sequence of iterations, continue with a next iteration of the sequence of iterations until a number of strings of n bits has not been rejected which is equal or above a predefined number of bit strings.

5. The security device of claim 4, wherein, in each iteration of the sequence of iterations, the AND combiner circuit is configured to determine the AND combinations of the sampled bits for all of the strings of bits that were sampled in the iteration concurrently.

6. The security device of claim 4, wherein, in each iteration of the sequence of iterations, the AND-OR combiner circuit is configured to determine the AND combination of the most significant bit of the sampled bits with the OR combination of the other bits of the sampled bits for all of the strings of bits that were sampled in the iteration concurrently.

7. The security device of claim 1, wherein, in each iteration of the sequence of iterations, the AND combiner circuit is configured to determine the AND combination of the sampled bits by means of a masked AND operation.

8. The security device of claim 1, wherein, in each iteration of the sequence of iterations, the AND-OR combiner circuit is configured to determine the AND combination of the most significant bit of the sampled bits with the OR combination of the other bits of the sampled bits by means of a masked AND operation and to perform the OR combination of the other bits of the sampled bits by means of a masked OR combination.

9. A method for generating a random number below a given limit in manner robust against side-channel attacks, comprising:
in each iteration of a sequence of iterations
sampling a string of n bits;
rejecting the string of n bits in reaction to
an AND combination of the sampled bits being equal to 1, in case the given limit or an integer multiple of the given limit is equal to 2ⁿ⁻¹,
an AND combination of the most significant bit of the sampled bits with an OR combination of the other bits of the sampled bits being equal to 1 in case the given limit is equal to 2ⁿ⁻¹+1; and
continuing with a next iteration of the sequence of iterations in reaction to the bit string rejector rejecting the string of n bits and stopping the sequence of iterations in reaction to a number of strings of n bits which have not been rejected being equal or above a predefined number of bit strings.
